(19) United States
(12) Patent Application Publication
(10) Pub. No.: US 2017/0171766 A1
(43) Pub. Date: Jun. 15, 2017

(54) FINE TIMING MEASUREMENT

(71) Applicant: Yuval Amizur, Kfar-Saba (IL)

(72) Inventor: Yuval Amizur, Kfar-Saba (IL)

(21) Appl. No.: 15/088,953

(22) Filed: Apr. 1, 2016

Related U.S. Application Data
(60) Provisional application No. 62/266,633, filed on Dec. 13, 2015.

(51) Int. Cl. H04W 24/08; H04W 72/08

(52) U.S. Cl. CPC H04W 24/08; H04W 72/085

(57) ABSTRACT

This disclosure describes access points, devices, and methods related to a fine timing measurement (FTM) protocol. For example, a method may be provided, wherein the method includes determining the number of symbols to send to a device; determining a fine timing measurement (FTM) response frame in response to receiving at least one FTM request frame, wherein the FTM response frame comprises the determined number of symbols; determining a null data packet (NDP) comprising the number of determined symbols; and determining to transmit the FTM response frame to the device.

### CROSS REFERENCE TO RELATED APPLICATION

This application claims the benefit of U.S. Patent Application No. 62/266,633 filed on Dec. 13, 2015, the disclosure of which is incorporated herein by reference as set forth in full.

### TECHNICAL FIELD

This disclosure generally relates to systems and methods for locating a device using wireless signals, and more specifically fine timing measurement (FTM) to locate the device.

### BACKGROUND

Devices may be tracked outdoors using various global-navigation-satellite-systems (GNSS) (e.g., global positioning system (GPS), GALILEO system, and global navigation satellite system (GLONASS) etc.). However, these systems may be faced with challenges when tracking devices that are indoors.

### BRIEF DESCRIPTION OF THE DRAWINGS

FIG. 1 depicts an example network environment of an illustrative wireless network, according to one or more example embodiments of the disclosure.

FIG. 2 depicts an exemplary null-data packet (NDP) and exemplary fields of the NDP, according to one or more example embodiments of the disclosure.

FIG. 3 depicts exemplary subfields of the exemplary NDP, according to one or more example embodiments of the disclosure.

FIG. 4 depicts exemplary subfields of an exemplary fine timing measurement (FTM) request frame, according to one or more example embodiments of the disclosure.

FIG. 5 depicts exemplary subfields of an exemplary FTM response frame, according to one or more example embodiments of the disclosure.

FIG. 6 depicts a flow diagram of an illustrative method for implementing an FTM protocol described herein, according to one or more example embodiments of the disclosure.

FIG. 7 depicts a flow diagram of an illustrative method for implementing an FTM protocol described herein, according to one or more example embodiments of the disclosure.

FIG. 8 depicts a block diagram of an example computing device, according to one or more example embodiments of the disclosure.

FIG. 9 depicts an example radio unit, according to one or more example embodiments of the disclosure.

FIG. 10 depicts an example computational environment, according to one or more example embodiments of the disclosure.

FIG. 11 depicts an example computing device, according to one or more example embodiments of the disclosure.

The detailed description is set forth with reference to the accompanying drawings, which are not necessarily drawn to scale. The use of the same reference numbers in different figures indicates similar or identical items. Illustrative embodiments will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Indoor navigation differs from outdoor navigation, because indoor environments may perturb the reception of signals from GNSS satellites. As a result, efforts are being made to solve the problem of indoor navigation.

A potential solution, as disclosed herein, is a fine timing measurement (FTM) protocol. A first device implementing the FTM protocol may measure a round trip time (RTT) of at least two signals sent from the first device to at least one second device in order to determine the first device's location. In some embodiments, the access point (AP) (e.g., referred to as a responding device) may only send and measure the RTT of at least two signals sent to at least one user device (e.g., referred to as an initiating device), within a predetermined period of time. This is commonly referred to as a burst period. In this embodiment, the burst period may provide a first level of resolution and/or location accuracy of the initiating device. A level of resolution may refer to a quantization level with which time is recorded by a processor in the AP or at least one user device. The quantization level may be the time intervals with which the processor records continuous time. For example, a processor with a quantization level corresponding to time intervals in nanoseconds may have a higher quantization level than a processor that has a quantization level corresponding to time intervals in microseconds (i.e., nanoseconds are shorter time intervals and therefore more intervals of time may be recorded thereby providing a higher level of resolution). In other embodiments, the initiating device may send and measure the RTT of at least two signals to a combination of access points and other devices (e.g., responding devices), in a burst period, thereby enabling the initiating device to perform trilateration to determine its location. This may provide a second level of resolution and/or location accuracy that is greater than the first level of resolution and/or location accuracy. In order to achieve greater resolution and/or accuracy, the number of signals sent in a burst period may be increased beyond the at least two signals. This will inevitably cause a processor in the initiating and/or responding device(s) to consume more bandwidth and spend more processor resources to determine the location of the initiating device, thereby detracting from the processor resources that may be used for other purposes (e.g., connecting a VoIP call via Wi-Fi, surfing a web browser, connecting to a virtual private network (VPN)). One scenario in which this might be useful is when an initiating device is highly dynamic, and travels over great distances in a short period of time relative to a responding device(s) resulting in changes to a channel between the initiating device and the responding device(s). However, in the case where the initiating device is carried by a person walking or running, the distances traveled by the initiating device, during the burst period, may not warrant using a greater resolution. This is because the distance traveled during the burst period may either be equal to zero or approximately equal to zero because the amount of time elapsed during consecutive burst periods may be significantly less than the time corresponding to the velocity at which the person is moving (e.g., the amount of time elapsed during the burst period is less than the amount of time elapsed by the person covering a certain distance). Because of this situation, the channel between the initiating device and responding device(s) is approximately the same over consecutive burst periods and therefore is highly correlated across the burst periods. The additional signaling overhead during the burst period only increases the resolution and/or accuracy to certain points beyond which the initiating device begins to experience a diminishing marginal return in resolution and/or accuracy.

As mentioned above, the bandwidth consumed by the devices increases with the number of signals sent between an initiating device and a responding device. This same problem may arise when the number of initiating devices increases beyond a certain number, and the responding device(s) have to accommodate the signals of the additional responding device(s). The problem may be further compounded if both scenarios occur at the same (e.g., the number of initiating devices sending signals during the burst periods increases beyond a point that may be supported by the available bandwidth).

The systems and methods disclosed herein address the problem of providing a desired resolution and/or accuracy for devices attempting to determine their location while decreasing the overhead (e.g., signals sent between the initiating and responding device(s)) needed to provide the desired resolution and/or accuracy.

Discussions herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or another electronic computing device, that manipulate and/or transform data represented as physical (e.g., electronic) quantities within the computer's registers and/or memories into other data similarly represented as physical quantities within the computer's registers and/or memories or other information storage mediums that may store instructions to perform the operations and/or processes.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object, merely indicates that different instances of like objects are being referred to, and are not intended to imply that the objects so described must be in a given sequence, either temporally, spatially, in ranking, or in any other manner.

Some embodiments may be used in conjunction with various devices and systems, for example, a user equipment (UE), a mobile device (MD), a wireless station (STA), a personal computer (PC), a desktop computer, a mobile computer, a laptop computer, a notebook computer, a tablet computer, a server computer, a handheld computer, a handheld device, an internet of things (IoT) device, a sensor device, a personal digital assistant (PDA) device, a handheld PDA device, an on-board device, an off-board device, a hybrid device, a vehicular device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

In some embodiments, the devices and/or networks disclosed herein may operate in accordance with existing wireless fidelity (WiFi) alliance (WFA) specifications. Yet in other embodiments, the devices and/or networks disclosed herein may operate in accordance with existing WFA peer-to-peer (P2P) specifications (WiFi P2P Technical Specification, Version 1.5, Aug. 4, 2014) and/or future versions and/or derivatives thereof. Still further in other embodiments, the devices and/or networks disclosed herein may operate in accordance with existing wireless-gigabit-alliance (WGA) specifications (Wireless Gigabit Alliance, Inc. WiGig MAC and PHY Specification Version 1.1, April 2011, Final Specification) and/or future versions and/or derivatives thereof. In other embodiments, the devices and/or networks disclosed herein may operate in accordance with existing IEEE 802.11 standards (IEEE 802.11-2012, IEEE Standard for Information Technology Telecommunications and Information Exchange Between Systems—Local and Metropolitan Area Networks—Specific Requirements—Part 11: Wireless LAN Medium Access Control INIAC) and Physical Layer (PHY) Specifications, Mar. 29, 2012; IEEE802.11ac-2013 (IEEE P802.11ac-2013, IEEE Standard for Information Technology—Telecommunications and Information Exchange Between Systems Local and Metropolitan Area Networks—Specific Requirements—Part 11: Wireless LAN Medium Access Control (MAC) and Physical Layer (PHY) Specifications Amendment 4: Enhancements for Very High Throughput for Operation in Bands below 6 GHz—December 2013); IEEE 802.11ad (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band—Dec. 28, 2012); IEEE-802.11REVmc (IEEE 802.11-REVmc™/D3.0, June 2014 Draft Standard for Information Technology Telecommunications and Information Exchange Between Systems—Local and Metropolitan Area Networks—Specific Requirements Part 11: Wireless LAN Medium Access Control (MAC) and Physical Layer (PHY) Specification); IEEE 802.11ax and/or IEEE 802.11az (IEEE 802.11az: Next Generation Positioning), and/or future versions and/or derivatives thereof. In other embodiments, the devices and/or networks disclosed herein may operate in accordance with existing cellular specifications and/or protocols, e.g., 3rd generation partnership project (3GPP), 3GPP long term evolution (LTE), and/or future versions and/or derivatives thereof. Further still, in some embodiments, the devices and/or networks disclosed herein may operate in accordance with existing worldwide interoperability microwave access (WiMAX) standards and/or future versions and/or derivatives thereof. In other embodiments, the devices and/or networks disclosed herein may operate in accordance with existing Zigbee alliance standards and/or future versions and/or derivatives thereof.

Some embodiments may be used in conjunction with one-way and/or two-way radio communication systems, cellular radio-telephone communication systems, a mobile phone, a cellular telephone, a wireless telephone, a personal communication systems (PCS) device, a PDA device which incorporates a wireless communication device, a mobile or portable global positioning system (GPS) device, a device which incorporates a GPS receiver, transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems, for example, radio frequency (RF), infrared (IR), frequency-division multiplexing (FDM), orthogonal FDM (OFDM), orthogonal frequency-division multiple access (OFDMA), FDM time-division multiplexing (TDM), time-division multiple access (TDMA), multi-user MIMO (MU-MIMO), spatial division multiple access (SDMA), extended TDMA (E-TDMA), general packet radio Service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee™, ultra-wideband (UWB), global system for mobile communication (GSM), 2G, 2.5G, 3G, 3.5G, 4G, fifth generation (5G) or sixth generation (6G) mobile networks, 3GPP, long term evolution (LTE), LTE advanced, enhanced data rates for GSM evolution (EDGE), or the like. Other embodiments may be used in various other devices, systems, and/or networks.

The term “user device,” as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “user device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a wireless fidelity (WiFi) network. Other embodiments may be used in conjunction with any other suitable wireless communication network, for example, a wireless area network, a “piconet,” a WPAN, a WVAN, and the like.

Some demonstrative embodiments may be used in conjunction with a wireless communication network communicating over a frequency band of 2.4 or 5 Gigahertz (GHz). However, other embodiments may be implemented utilizing any other suitable wireless communication frequency bands, for example, a 60 GHz band, a millimeterWave (mmWave) frequency band, a Sub 1 GHz (S1G) frequency band, a WLAN frequency band, a WPAN frequency band, and the like.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device,” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology. Embodiments disclosed herein generally pertain to wireless networks. Some embodiments may relate to wireless networks that operate in accordance with one or more of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

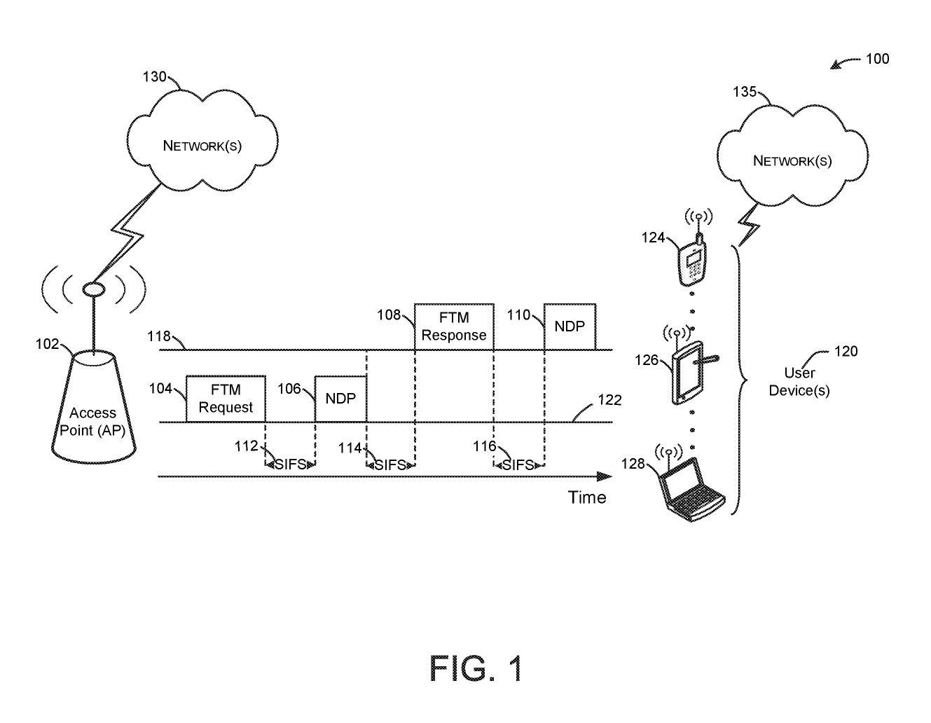

FIG. 1 depicts an example network environment of an illustrative wireless network, according to one or more example embodiments of the disclosure. The illustrative wireless network 100 in FIG. 1 may include one or more AP(s) 102 that may communicate with one or more user device(s) 120, in accordance with IEEE 802.11 communication standards, including IEEE 802.11ax. The one or more user device(s) 120 and the one or more APs 102 may be devices that are non-stationary without fixed locations or may be stationary with fixed locations.

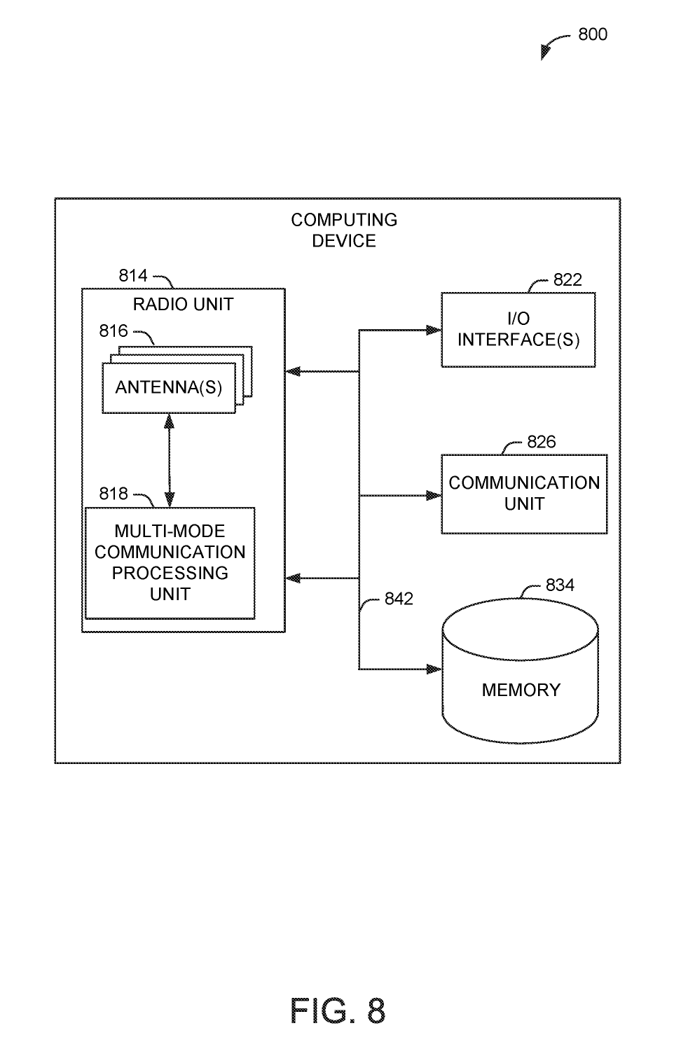

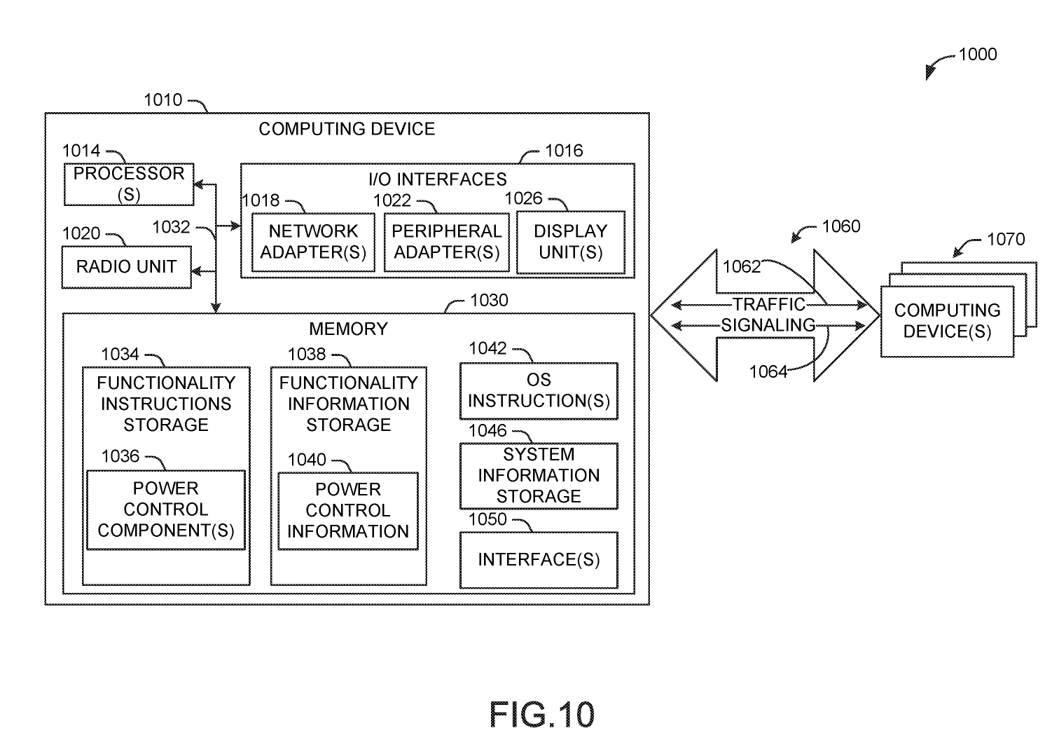

In some embodiments, the user device(s) 120 and the AP 102 may include one or more computer systems having a configuration similar to that depicted in FIG. 8 and/or a configuration similar to the example machine/system depicted in FIGS. 10 and/or 11. One or more illustrative user device(s) 120 may be operable by one or more user(s) (not shown). The user device(s) 120 (e.g., user devices 124, 126, or 128) may include any suitable processor-driven user device including, but not limited to, a desktop user device, a laptop user device, a server, a router, a switch, an access point, a smartphone, a tablet, a wearable wireless device (e.g., a bracelet, a watch, glasses, a ring, etc.) and so forth. Any of the user devices 120 (e.g., user devices 124, 126, or 128) may be configured to communicate with each other and/or any other component of the wireless network 100 via one or more communications networks 130, 135 wirelessly or wired.

In this environment, the user devices(s) 120 may communicate with each other and transmit data packets and null-data packets on an operating channel. The user device(s) 120 may randomly access an operating channel to transmit data packets, and may randomly access the same operating channel or another operating channel to transmit null-data packets. In some embodiments, the user device(s) 120 may transmit data packets during a data packet period, or first period, and may transmit null-data packets during a null-data packet period, or second period. In other embodiments, data packets may be interspersed with null-data packets. For example, the user device(s) 120 may transmit a null-data packet followed by several consecutive data packets which are subsequently followed by several consecutive null-data packets. The data and null-data packets may be transmitted among the user device(s) 120, and/or to the AP 102. In some embodiments, the user device(s) 120 may transmit data packets to the AP 102 to connect to the Internet (e.g., connecting a VoIP call via Wi-Fi, surfing a web browser, connecting to a virtual private network (VPN), etc.) and may transmit null-data packets to the other user device(s) 120 and the AP 102 to execute the FTM protocol. In some embodiments, the user device(s) 120 may only send null-data packets to the AP 102. Null-data packets may comprise one or more preambles corresponding to one or more orthogonal frequency division multiplexing (OFDM) symbols.

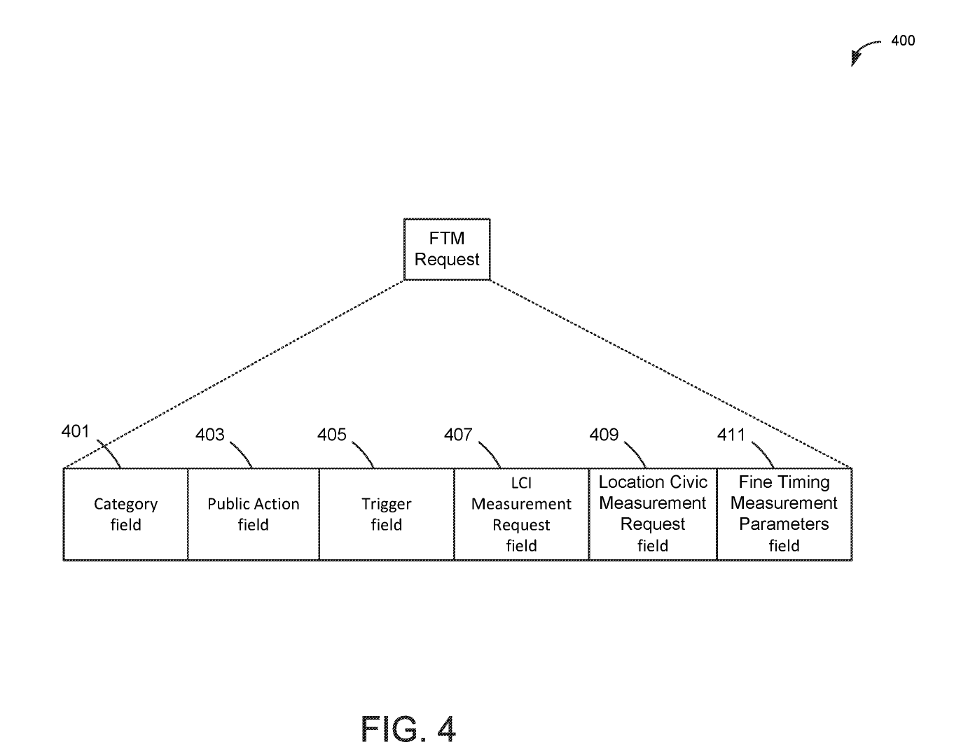

In the case of the FTM protocol, the user device(s) (e.g., the user device(s) 120) may transmit an FTM request frame (e.g., the FTM request 104) to an AP (e.g., the AP 102) followed by a null-data packet (NDP) (e.g., the NDP 106) separated by a short interframe space (SIFS) period (e.g., the SIFS 112). It is understood that the SIFS is the minimum time between the last symbol of a frame and the beginning of the first symbol of a next frame. In some embodiments, the SIFS period may be equal to 10 microseconds. In other embodiments, the SIFS period may be less than 10 microseconds. For example if the AP 102 comprises more than one physical layer interface (e.g., I/O interface(s) 822 of FIG. 8 or network adapter(s) 1018 in I/O interfaces 1016 of FIG. 10), the SIFS period may be less than 10 microseconds. The FTM request frame may comprise a plurality of fields, as illustrated in FIG. 4, and described below in reference to FIG. 4. The FTM request frame may be used by the user device(s) to initiate the FTM protocol by sending the FTM request to the AP which may, in turn, respond by transmitting an FTM response frame (e.g., the FTM response 108). After the user device(s) transmit the FTM request frame, a period of time equivalent to the nominal time (in microseconds) required by the MAC and PHY layers in the user device(s) to receive the last symbol of a frame at an air interface of the user device(s), then to process the frame, and respond with a first symbol on the air interface of the earliest possible response frame, may elapse before the user device(s) send a subsequent frame or packet. This period of time may be referred to as the SIFS. In some embodiments, the SIFS may be the same for the user device(s) and the AP. In other embodiments, the SIFS may be different for the different user devices and APs. In some embodiments, an SIFS period may be shortened or lengthened. In general, the SIFS may be dependent on the hardware of the user device.

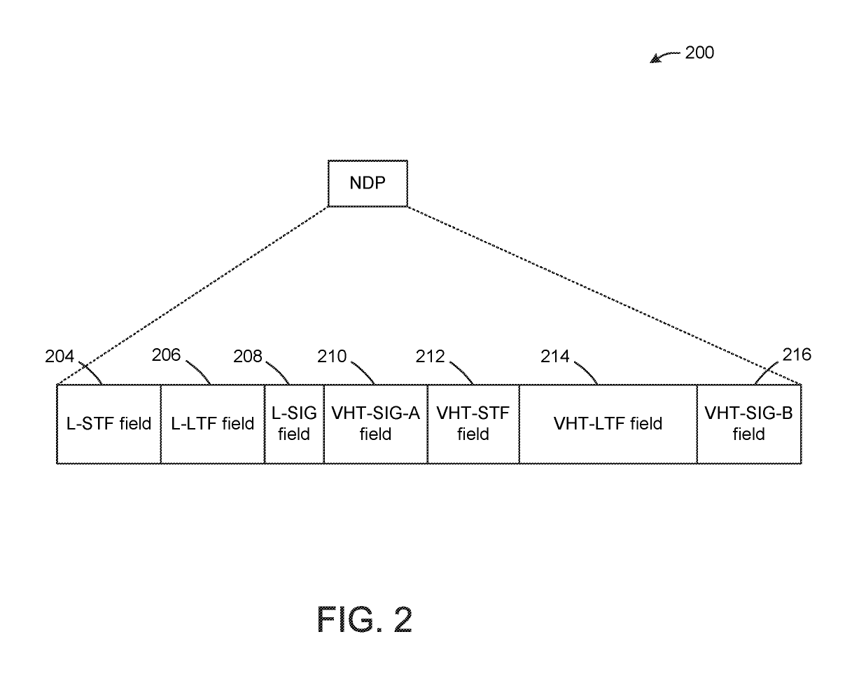

As illustrated in FIG. 1, the FTM request 104 and the NDP 106 may be separated by the SIFS 112 in time. The transmission timeline for an initiating device (e.g., the user device(s) 120) may be indicated by initiating device timeline 122, and the timeline for a responding device (e.g., the AP 102) may be indicated by the responding device timeline 118. In some embodiments, the initiating device may be the AP 102, and the responding device may be the user device(s) 120. After the SIFS, the user device(s) may transmit an NDP to the AP (e.g., the NDP 106). The NDP may comprise a plurality of fields, as illustrated in FIG. 2, and described below in reference to FIG. 2.

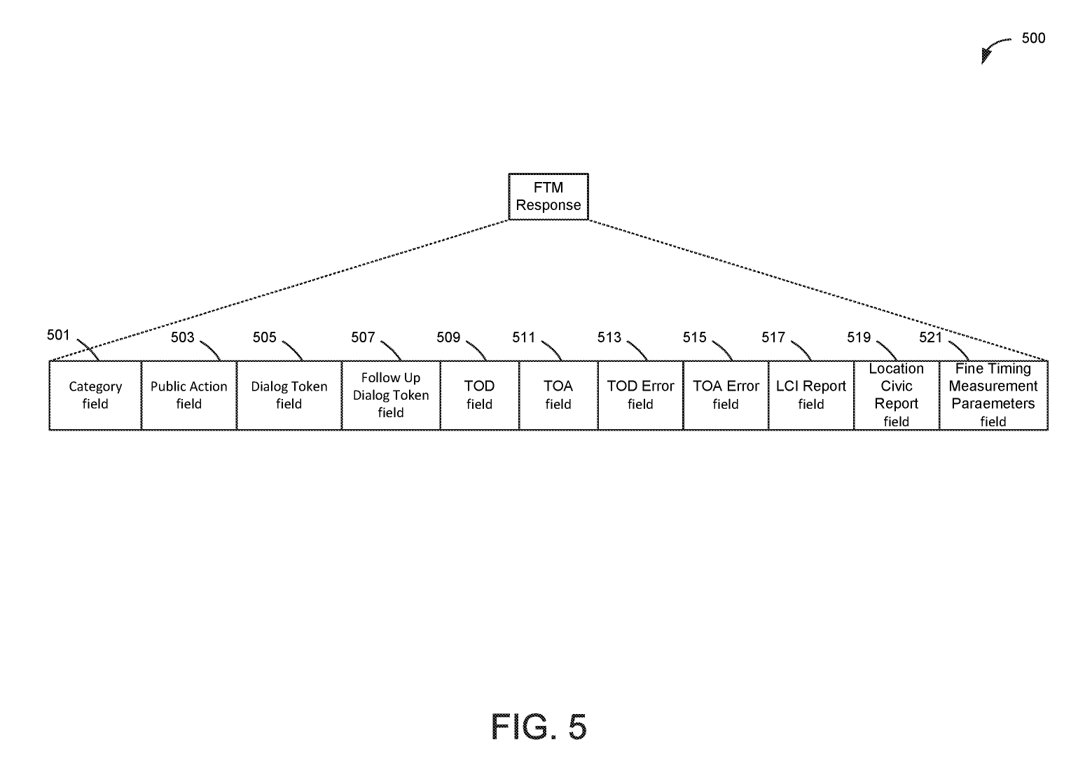

After the user device(s) send the NDP, the AP may respond by transmitting an FTM response frame (e.g., the FTM response 108) to the user device(s) after an SIFS (e.g., the SIFS 114) and then wait another SIFS (e.g., the SIFS 116) before transmitting an NDP (e.g., the NDP 110) to the user device(s). The FTM response 108 may include a plurality of fields, as illustrated and described below in FIG. 5. In some embodiments, the NDP 110 may comprise the same fields as those in the NDP 106.

Any of the communications networks 130 and 135 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and the AP 102 may include one or more communications antennas. A communications antenna may be any suitable type of antenna corresponding to the communications protocols used by the user device(s) 120 (e.g., user devices 124, 126, and 128), and the AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, or 128) and the AP 102 may include any suitable radio and/or transceiver for transmitting and/or receiving radio frequency (RF) signals in the bandwidth and/or channels corresponding to the communications protocols utilized by any of the user device(s) 120 and the AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n), 5 GHz channels (e.g., 802.11n, 802.11ac), or 60 GHz channels (e.g., 802.11ad). In some embodiments, non-Wi-Fi protocols may be used for communications between devices, such as Bluetooth, dedicated short-range communication (DSRC), ultra-high frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

FIG. 2 depicts an example null-data packet 200 that may be comprised of one or more fields, according to one or more example embodiments of the disclosure.

In this example, the NDP 200 may comprise a plurality of fields including a legacy short training field (L-STF field) (e.g., the L-STF field 204), a legacy long training field (L-LTF field) (e.g., the L-LTF field 206), a legacy signal field (L-SIG field) (e.g., the L-SIG field 208), a very high throughput signal A field (VHT-SIG-A field) (e.g., the VHT-SIG-A field 210), a very high throughput short training field (VHT-STF field) (e.g., the VHT-STF field 212), a very high throughput long training field (VHT-LTF field) (e.g., the VHT-LTF field 214), and a very high throughput signal B field (VHT-SIG-B field) (e.g., the VHT-SIG-B field 216). These fields may be transmitted by user devices and APs using orthogonal frequency division multiplexing (OFDM) techniques. The user devices and the AP may provide data payload communication capabilities of 6, 9, 12, 18, 24, 36, 48, and 54 megabits per second (Mb/s). The user devices and the AP may support transmitting and receiving at data rates of 6, 12, and 24 Mb/s. The user devices and the AP may use subcarriers that are modulated using binary or quadrature phase shift keying (BPSK or QPSK) or using 16- or 64-quadrature amplitude modulation (16-QAM or 64-QAM). Forward error correction coding (convolutional coding) is used with a coding rate of 1/2, 2/3, or 3/4. It is understood that the above descriptions are for purposes of illustration and are not meant to be limiting.

The L-STF field 204 may comprise a short training sequence comprising 10 short OFDM symbols that may be used to adjust convergence of an automatic gain control (AGC), and to determine diversity selection, timing acquisition, and frequency acquisition in a receiving wireless device. The L-LTF field 206 may comprise a long training sequence comprising two long OFDM symbols that may be used to estimate a channel between an initiating device and a responding device and determine fine frequency acquisition of the responding device. The L-SIG field 208 may comprise a plurality of subfields including a data rate subfield, a length subfield, and a tail subfield. The data rate subfield may comprise a binary number corresponding to a data rate used to transmit a physical layer service data unit (PSDU) in Mb/s. In some embodiments, the data rate may be 6, 9, 12, 18, 24, 36, 48, and 54 divided by 7.5 for 6 MHz and 7 MHz unit channels and by 5.625 for 8 MHz channels. The length subfield may comprise a binary number corresponding to a length of the PSDU in octets in the range of 1 to 4095. This value may be used to determine the number of octet transfers occurring between the MAC and the PHY. The VHT-SIG-A field 210 may comprise a plurality of subfields that may be used to decode very high throughput (VHT) physical protocol data units (PPDUs) received at a responding device. The VHT-STF field 212 may comprise a plurality of subfields that may be used, by a responding device, to adjust the estimation of the AGC of the responding wireless device in an MIMO transmission.

In some embodiments, the VHT-LTF field 214 may provide a responding device with information to estimate an MIMO channel between a set of constellation mapper outputs (or, if space time block coding (STBC) is used, the STBC encoder outputs) and the receive chains. The initiating device(s) may provide training for a plurality of space-time streams (spatial mapper inputs) used for the transmission of a physical layer service data unit (PSDU). For each tone, the MIMO channel may be estimated, and there may be a matrix corresponding to channel estimates between antennas on the initiating device and antennas on the responding device(s). The entries in the matrix may correspond to the spatial streams received by the antennas on the responding device(s) wherein the rows correspond to the number of receiving antennas on the responding device(s), and the columns correspond to the number of space-time streams between the initiating device(s) and the responding device(s). The data tones of symbols in the VHT-LTF field 214 may be multiplied by entries in a P matrix, to enable channel estimation at the responding device(s). The VHT-LTF field 214 may also comprise pilot tones that may cause the responding device(s) to track the phase and frequency offset during an estimation of an MIMO channel. In some embodiments, the number of symbols used in the VHT-LTF field 214 may be a function of the total number of space-time streams. For instance, the VHT-LTF field 214 may be sent using one, two, four, six, or eight symbols.

In other embodiments, the number of symbols may be based on desired signal-to-noise ratio (SNR) at the responding device. For instance, an initiating device or a responding device may determine that the SNR should be adjusted, and may determine the number of VHT-LTF symbols required to achieve the desired SNR. For example, the SNR may be decreased to a certain number of decibels (dBs) in response to the number of unique VHT-LTF symbols transmitted from the initiating device to the responding device. For instance, it may be determined by the initiating device that the unique VHT-LTF symbols should be transmitted a certain number of times to decrease the SNR to the desired number of dBs. In some embodiments, if an initiating device transmits two unique symbols, twice each, the SNR at a responding device may be decreased by three dBs. In other embodiments, if an initiating device transmits four unique symbols, four times each, the SNR at a responding device may be decreased by six dBs. Yet still in other embodiments, the number of times a unique symbol is transmitted may not be the same number of times another unique symbol is transmitted. For instance, a first symbol may be transmitted four times, a second symbol may be transmitted four times, a third symbol may be transmitted two times, and a fourth symbol may be transmitted one time.

As an example, the user device(s) 120 (initiating device) may send the FTM request 104 to the AP 102 (responding device) followed by the NDP 106 separated by SIFS 112. The NDP 106 may comprise the fields in NDP 200 as described above. The FTM request 104 may include a repetition factor indicating the number of unique symbols that will be sent by the initiating device to the responding device and the number of times the unique symbols will be transmitted. The FTM request 104 may comprise the fields in the FTM request 400 of FIG. 4, and the repetition factor may be included in the fine timing measurement parameters field 411. In other embodiments, it may be included in another field of the FTM request 400 of FIG. 4. The repetition factor may determine the number of unique symbols and the number of times the unique symbols are transmitted in the VHT-LTF field 214 in the NDP 200. Once the AP 102 receives the FTM request 104, it may wait for the SIFS 112 to elapse and record the time when the first symbol in the VHT-LTF 214 arrives. The AP 102 may then determine an estimation of the channel, and may send an estimation of the channel back to the user device(s) 120. The AP 102 may send the estimation of the channel to the user device(s) 120 in the FTM response 108. The FTM response 108 may be comprised of the fields in the FTM response 500 of FIG. 5, and the estimation of the channel, may be included in a field of the FTM response 500 of FIG. 5 as explained below. In some embodiments, a time of arrival (TOA) of the FTM request 104 and/or the NDP 106 at the AP 102 may be included in the FTM response 108. For example, the TOA may be transmitted in TOA field 511 of FIG. 5. The TOA may be the time of arrival of the first symbol on the air interface of a device (e.g., the first symbol in the FTM request 104 or the NDP 106). The estimation of the channel may be used by the user device(s) 120 to steer subsequent transmissions of FTM requests and NDPs to increase the resolution and/or accuracy of the TOA at the AP 102, thereby increasing the resolution and/or accuracy of the calculation of the location of the user device(s) 120 relative to the AP 102. In some embodiments, a time of delivery (TOD) corresponding to when the FTM response 108 and/or the NDP 110 is transmitted by the responding device (e.g., the AP 102) may also be included in the FTM response 108. The TOD may be the time at which the first symbol has been completely transmitted on the air interface of a device (e.g., the AP 102). The user device(s) 120 may use the estimate of the channel to calculate the TOA of the FTM request 104 and the NDP 106 at the AP 102. The estimate of the channel may also be used to generate a steering matrix that may be used to steer transmission streams associated with data to be transmitted to the AP 102 to the correct transmitting antenna(s) on the user device(s) 120 in order to adjust the SNR at the AP 102. The steering matrix may also be used to determine the phase with which the transmission streams should be transmitted to adjust the SNR at the AP 102. In some embodiments, the steering matrix may determine the antennas that the transmission streams should be transmitted on, and the phases with which the transmission streams should be transmitted in order to reduce the SNR at the AP 102.

The VHT-SIG-B field (e.g., the VHT-SIG-B 216) may be comprised of at least one field including, but not limited to, the length of the VHT-SIG-B field, the modulation and coding scheme (MCS) used to transmit the NDP 200, a reserved field, a tail field that may be used to decode other parts of the NDP 200, and the total number of bits in a PPDU that the NDP 200 is transmitted in.

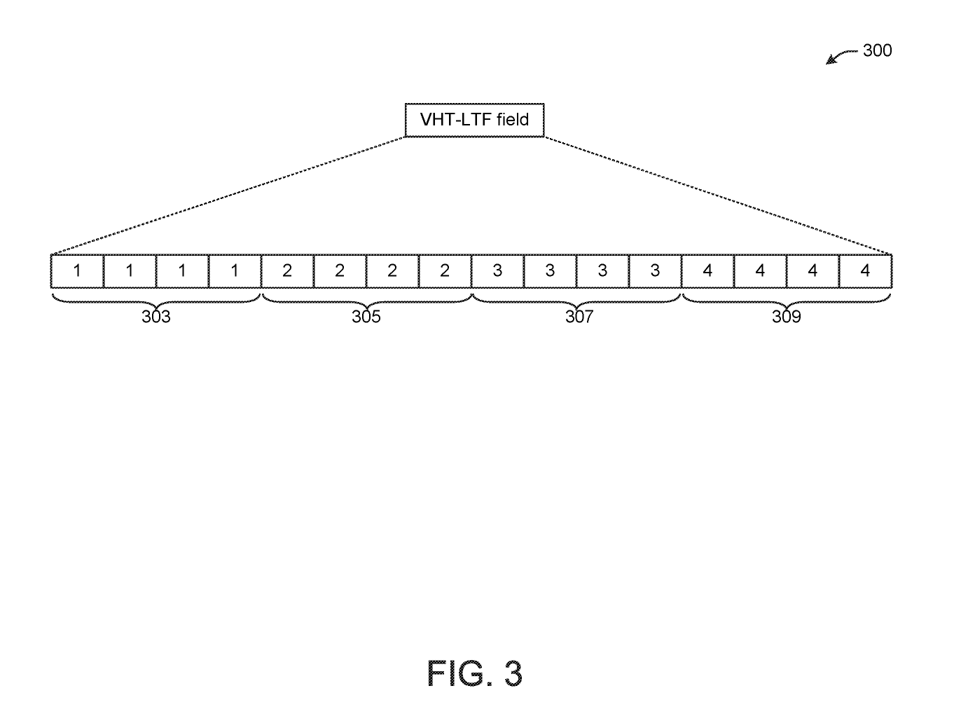

FIG. 3 depicts exemplary subfields of the exemplary NDP, according to one or more example embodiments of the disclosure. In particular, FIG. 3 depicts an exemplary VHT-LTF subfield of the exemplary NDP, according to one or more example embodiments of the disclosure. The VHT-LTF field 300 may be the same as the VHT-LTF field 214 of FIG. 2 and may comprise at least one OFDM symbol. In exemplary FIG. 3, the VHT-LTF field 300 is shown to comprise 16 symbols. The symbols 303 may comprise four of a same first unique OFDM symbol, the symbols 305 comprise four of a same second unique OFDM symbol, the symbols 307 comprise four of a same third unique OFDM symbol, and the symbols 309 comprise four of a same fourth unique OFDM symbol. The number of unique OFDM symbols included in the VHT-LTF field 300 may be based at least in part on a desired SNR at a responding device (e.g., the AP 102). For example, if the SNR at the responding device must be decreased by six dBs to achieve the desired SNR, four unique OFDM symbols may be transmitted in the VHT-LTF field 300 in order to decrease the SNR at the responding device by six dBs. This is only exemplary, and the devices, systems, and methods disclosed herein are not limited to this example.

In other embodiments, the SNR at the responding device may be decreased by three dBs if two unique OFDM symbols are transmitted twice each. In some embodiments, the number of OFDM symbols may be a function of the number of dBs the SNR must be adjusted (i.e., increased or decreased) at the responding device. In some embodiments, the reduction in SNR may be expressed as a logarithmic function of the number of transmitted symbols. Therefore the number of transmitted symbols may be calculated by a processor in the initiating device and/or the responding device to achieve a desired SNR by raising the number 10 to the desired SNR (i.e., a number of symbols is equal to 10^{sNR}, where SNR corresponds to the desired SNR). This is only exemplary, and the devices, systems, and methods disclosed herein are not limited to this example.

FIG. 4 depicts exemplary subfields of an exemplary FTM request 400 frame, according to one or more example embodiments of the disclosure. The FTM request 400 frame may be used by an initiating device (e.g., user device(s) 120) to initiate the FTM protocol. The FTM request 400 frame may be comprised of one or more of the fields. The FTM request 400 may comprise a category field (e.g., the category field 401), a public action field (e.g., the public action field 403), a trigger field (e.g., the trigger field 405), an LCI measurement request field (e.g., the LCI measurement request field 407), a location civic measurement request field (e.g., the location civic measurement request field 409), and a fine timing measurement parameters field (e.g., the fine timing measurement parameters field 411).

The category field 401 is a field that may comprise data used to designate the contents of the public action field 403. The public action field 403 may comprise data used to restrict or grant communication abilities to an AP or user devices belonging to the same or different basic service sets (BSSs), and/or generic advertisement services (GASs). For instance, the public action field 403 may comprise data designating the restrictions and/or permissions for user devices to communicate with other user devices, APs to communicate with other APs, and/or for user devices to communicate with APs that belong to the same BSS (i.e., inter-BSS communication). The public action field 403 may also comprise information designating the restrictions and/or permissions for APs to communicate with associated and/or unassociated user devices. The public action field 403 may also comprise data designating the restrictions and/or permissions for user devices to communicate with other user devices, APs to communicate with other APs, and/or for user devices to communicate with APs that do not belong to the same BSS (i.e., intra-BSS communication). The public action field 403 may also comprise GAS data that provides functionality to enable a user device to discover the availability of information related to desired network services (e.g., information about services such as provided in a BSS, local access services, available subscription service providers (SSPs), and/or other external networks.

The trigger field 405 may be a binary value wherein a first binary value (e.g., 1) indicates that the initiating device (e.g., the user device(s) 120 of FIG. 1) requests that the responding device (e.g., the AP 102 of FIG. 1) start or continue sending FTM response frames, and a second binary value (e.g., 0) indicates that the initiating device (e.g., the user device(s) 120 of FIG. 1) requests the responding device (e.g., the AP 102 of FIG. 1) to stop sending FTM response frames. The trigger field 405 may cause the responding device of the FTM request 400 to send an FTM response frame (e.g., the FTM response 500 of FIG. 5).

The location configuration information (LCI) measurement request field 407 may be an optional field; in some embodiments it may be included, and in others it may be omitted. If the LCI measurement request field 407 is included in the FTM request 400, it may comprise data requesting latitude, longitude, and altitude, with uncertainty indicators of the initiating device from the responding device.

The location civic measurement request field 409 may be an optional field; in some embodiments it may be included, and in others it may be omitted. If the location civic measurement request field 409 is included in the FTM request 400, it may comprise data requesting the civic location of the initiating device from the responding device. The data may comprise information about the country and the administrative units such as states, provinces, cities, street addresses, postal community names, and/or building information where the initiating device is located.

The fine timing measurement parameters field 411 may comprise data that may be used by the initiating device to request FTM configuration data from the responding device.

FIG. 5 depicts exemplary subfields of an exemplary FTM response frame, according to one or more example embodiments of the disclosure. In particular, FIG. 5 illustrates an FTM response (e.g., the FTM response 500) comprising a plurality of fields. The FTM response 500 may comprise a category field (e.g., the category field 501) which may comprise the same data as that in the category 401 field of FIG. 4. The FTM response 500 may also comprise a public action field (e.g., the public action field 503) which may comprise the same data as that in the public action field 403 of FIG. 4. The FTM response 500 may also comprise a dialog token field (e.g., the dialog token field 505). The dialog token field 505 may comprise data that may be used by the responding device (e.g., the AP 102 of FIG. 1) to respond to and/or service multiple FTM requests received from the user device(s) 120 of FIG. 1. The FTM response 500 may also comprise a follow up dialog token field (e.g., the follow up dialog token field 507), wherein the data in the follow up dialog token field 507 may comprise instructions determined by the responding device (e.g., the AP 102) to indicate that the field is a follow up FTM measurement frame, a time of delivery (TOD) field (e.g., the TOD field 509), a time of arrival field (TOA) (e.g., the TOA field 511), a time of delivery (TOD) error field (e.g., the TOD error field 513), or a time of arrival error field (e.g., the time of arrival error field 515). The TOD field 509 may comprise instructions which when executed by a processor in the initiating device may cause the initiating device to determine when the FTM response was transmitted by the responding device. The TOA field 511 may comprise instructions which when executed by the processor in the initiating device may cause the initiating device to determine when the FTM response arrived at the responding device. The TOD error field 513 may comprise instructions which when executed by a processor in the initiating device may cause the initiating device to determine an error in the recording of the TOD in the TOD field 509. For example, the responding device may experience clock drift in recording the TOD, and may indicate the amount of time that is estimated to have elapsed from the time the FTM response 500 is generated and when a processor in the responding device transmits the FTM response 500. The TOA error field 515 may comprise instructions which when executed by a processor in the initiating device may cause the initiating device to determine an error in the recording of the TOA in the TOA error field 515. For example, the responding device may experience clock drift in recording the TOA, and may indicate the amount of time that is estimated to have elapsed from the time the FTM request 400 is received by the processor in the responding device and the actual time the processor records the arrival of the FTM request 400 of FIG. 4. The FTM response 500 may comprise an LCI report field (e.g., the LCI report field 517) which may comprise instructions, which when executed by a processor in the initiating device upon receipt of the FTM response 500, may be executed to determine the latitude, longitude, altitude, and other information related to a location associated with the initiating device. The FTM response 500 may also comprise a location civic report field (e.g., the location civic report field 519) comprising instructions inputted into the location civic report field 519 by a processor in the responding device to indicate to the initiating device the civic location of the initiating device. The FTM Response 500 may also comprise a fine timing measurement parameters field (e.g., the fine timing measurement parameters field 521) which may comprise data similar to that in the fine timing measurement parameters field 411. The responding device may include a repetition factor in the fine timing measurement parameters field 521 that may include instructions which when executed by a processor in the initiating device may cause the initiating device to determine how many symbols and the number of times the symbols may be transmitted in an NDP from the responding device to the initiating device.

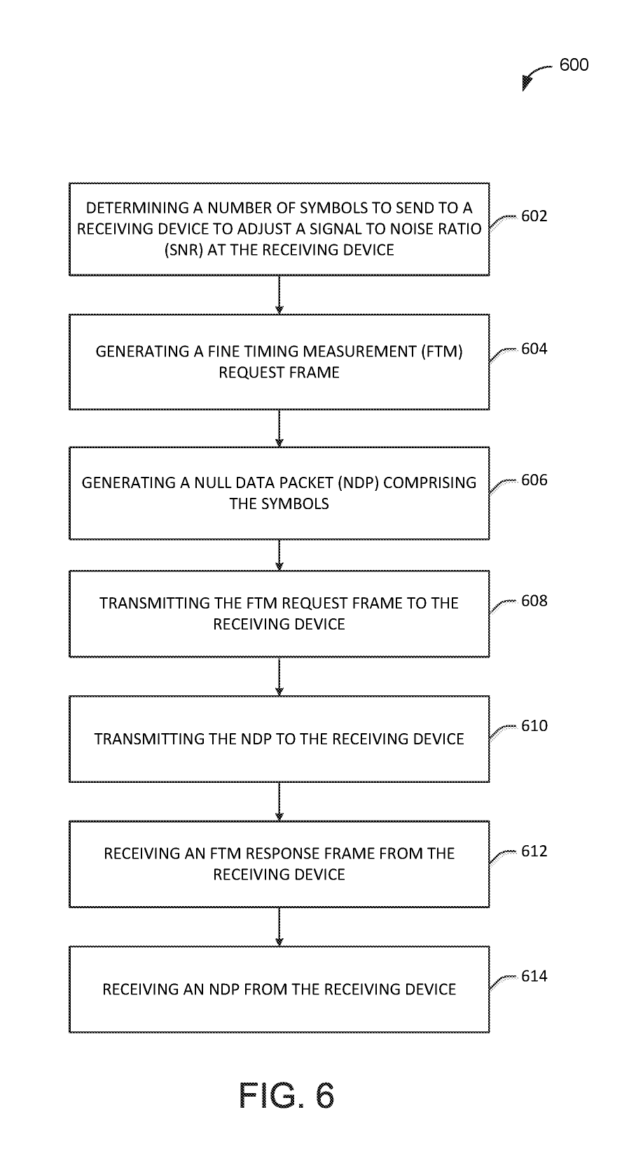

FIG. 6 depicts a flow diagram of an illustrative method for implementing an FTM protocol described herein, according to one or more example embodiments of the disclosure. In particular, FIG. 6 illustrates a sequence of steps that may be executed, in the form of computer-readable instructions, by a processor in an initiating device, to implement the FTM protocol described below. The instructions may or may not be executed in the same sequence as illustrated in FIG. 6.

At block 602, a processor in an exemplary initiating device may determine a number of unique OFDM symbols to send to a processor in an exemplary responding device in order to adjust or improve an SNR in the processor in the exemplary responding device. For example, the processor in the exemplary initiating device may determine that n unique OFDM symbols should be sent to the processor in the exemplary responding device. The number of symbols to send may be determined from previous sessions of the FTM protocol. In some embodiments, the number of symbols may be based on an approximate range and/or quality of estimates of the channel from previous FTM protocol sessions. In some embodiments, there may be no previous sessions for the exemplary initiating device to refer to in order to determine the number of symbols to send. In these embodiments, the processor in the exemplary initiating device may select a number corresponding to a predetermined SNR that may enable a processor in a responding device to receive the symbols with the predetermined SNR.

At block 604, the processor in the initiating device may generate an FTM request frame (e.g., the FTM request 400 of FIG. 4) to initiate an FTM protocol with the processor in the responding device. The processor in the initiating device may generate the fields (e.g., the category field 401, the public action field 403, the trigger field 405, the LCI measurement request field 407, the location civic measurement request field 409, and the fine timing measurement parameters field 411) in the FTM request 400 of FIG. 4, and may set the trigger field 405 to 1 to indicate to the processor in the responding device that the processor in the initiating device wants to start the FTM protocol. The processor in the initiating device may include the integer value of the number (i.e., n) of unique OFDM symbols in a field of the FTM request frame (e.g., the FTM request frame 400 of FIG. 4). For example, the integer value may be 4, and may be included in the fine timing measurement parameters field 411. The integer value may also represent the number of times each unique OFDM symbol will be repeated. For example, if the integer value is 4, then each of the four unique OFDM symbols may be transmitted by the processor in the initiating device to the processor in the responding device four times. This may be referred to as the repetition factor. In some embodiments, the repetition factor may be included in another field appended to the FTM request frame 400.

After the FTM request frame is generated, the processor in the exemplary initiating device may generate an NDP (e.g., the NDP 200 of FIG. 2) comprising the number of symbols (i.e., n) determined to be sent to the processor in the exemplary responding device in block 602 (block 606). The processor in the exemplary initiating device may generate the fields (e.g., L-STF field 204, L-LTF field 206, L-SIG field 208, VHT-SIG-A field 210, VHT-STF field 212, VHT-LTF field 214, and VHT-SIG-B field 216) of an NDP (e.g., the NDP 200 of FIG. 2). The processor in the exemplary initiating device may generate the n unique OFDM symbols, and insert the n unique OFDM symbols into a VHT-LTF field (e.g., the VHT-LTF field 214 of FIG. 2). In some embodiments, the processor in the exemplary initiating device may generate the NDP before or concurrently with the generation of the FTM request frame.

At block 608, the processor in the exemplary initiating device may transmit the FTM request frame to the processor in the exemplary responding device. After the processor at the exemplary initiating device transmits the FTM request frame, it may wait an SIFS period and then transmit the NDP in block 610. The processor at the exemplary initiating device may then receive an FTM response frame from the processor in the exemplary responding device after an SIFS period (block 612) and receive an NDP from the processor in the exemplary responding device (block 614) after another SIFS period.

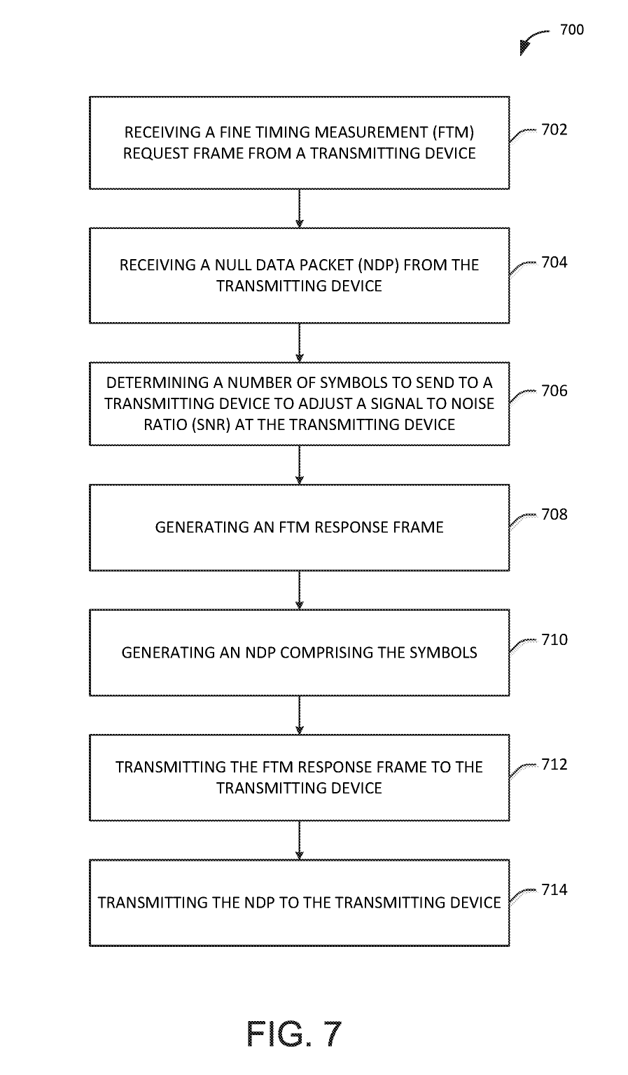

FIG. 7 depicts a flow diagram of an illustrative method for implementing an FTM protocol described herein, according to one or more example embodiments of the disclosure. In particular, FIG. 7 illustrates a sequence of steps that may be executed, in the form of computer-readable instructions, by a processor in a responding device, to implement the FTM protocol described below. The instructions may or may not be executed in the same sequence as illustrated in FIG. 7.

At block 702, a processor in an exemplary responding device may receive an FTM request frame (e.g., the FTM request 400 of FIG. 4) from a processor in an exemplary initiating device. After receiving the FTM request frame, the processor in the exemplary responding device may receive an NDP from the processor in the exemplary initiating device (block 704). In some embodiments, the processor in the exemplary responding device may receive the FTM request frame before or concurrently with the reception of the NDP from the processor in the exemplary initiating device.

After block 704, the processor in the exemplary responding device may determine a number of unique OFDM symbols that should be sent to the processor in the exemplary initiating device in order to adjust or improve an SNR in the processor in the exemplary initiating device (block 706). For example, the processor in the exemplary responding device may determine that m unique OFDM symbols should be sent to the processor in the exemplary initiating device. The number of symbols to send may be determined from previous sessions of the FTM protocol. In some embodiments, the number of symbols may be based on an approximate range and/or quality of estimates of the channel from previous FTM protocol sessions. In some embodiments, there may be no previous sessions for the exemplary initiating device to refer to in order to determine the number of symbols to send. In these embodiments, the processor in the exemplary initiating device may select a number corresponding to a predetermined SNR that may enable a processor in a responding device to receive the symbols with the predetermined SNR.

At block 708, the processor in the exemplary responding device may generate an FTM response frame (e.g., the FTM response 500 of FIG. 5). The FTM response frame may include an estimate of the channel between the processor in the exemplary responding device and the processor in the exemplary initiating device. The processor in the exemplary responding device may include the integer value of the number (i.e., m) of unique OFDM symbols in a field of the FTM response frame (e.g., the FTM response frame 500 of FIG. 5). For example, the integer value may be 4, and may be included in the fine timing measurement parameters field 521. In some embodiments, the repetition factor may be included in another field appended to the FTM response frame 500. The integer value also represents the number of times each unique OFDM symbol will be repeated. For example, if the integer value is 4, then each of the four unique OFDM symbols may be transmitted by the exemplary processor in the responding device to the exemplary processor in the initiating device four times. This may be referred to as the repetition factor as explained above. After the FTM response frame is generated at block 708, the processor in the exemplary responding device may generate an NDP (e.g., the NDP 200 of FIG. 2) comprising the number of symbols (i.e., m) determined to be sent to the processor in the exemplary initiating device in block 706 (block 710). The processor in the exemplary responding device may generate the fields (e.g., L-STF field 204, L-LTF field 206, L-SIG field 208, VHT-SIG-A field 210, VHT-STF field 212, VHT-LTF field 214, and VHT-SIG-B field 216) in the NDP 200 of FIG. 2. The processor in the exemplary responding device may generate the m unique OFDM symbols, and insert the m unique OFDM symbols into a VHT-LTF field (e.g., the VHT-LTF field 214). In some embodiments, the number of unique OFDM symbols generated by the processor in the exemplary initiating device (i.e., n) may be the same as the number of unique OFDM symbols generated by the processor in the exemplary responding device (i.e., m) if the channel estimate generated by the processor in the exemplary initiating device is the same as the channel estimate generated by the processor in the exemplary responding device. In some embodiments, the processor in the exemplary responding device may generate the NDP before or concurrently with the generation of the FTM response frame. At block 712, the processor in the exemplary responding device may transmit the FTM response frame to the processor in the exemplary initiating device, wait an SIFS period, and then transmit the NDP to the exemplary initiating device (block 714). In some embodiments, the processor in the exemplary responding device may transmit the NDP before or concurrently with the generation of the FTM response frame.

FIG. 8 illustrates a block diagram of an example embodiment of a computing device 800 that may operate in accordance with at least certain aspects of the disclosure. In one aspect, the computing device 800 may operate as a wireless device and may embody or may comprise an access point (e.g., AP 102), a mobile computing device (e.g., user device(s) 120), a receiving and/or a transmitting station, and/or other types of communication devices that may transmit and/or receive wireless communications in accordance with this disclosure. To permit wireless communication, including dynamic bit mapping techniques as described herein, the computing device 800 may include a radio unit 814 and a communication unit 826. In certain implementations, the communication unit 826 may generate data packets or other types of information blocks via a network stack, for example, and may convey data packets or other types of information blocks to the radio unit 814 for wireless communication. In one embodiment, the network stack (not shown) may be embodied in or may constitute a library or other types of programming modules, and the communication unit 826 may execute the network stack in order to generate a data packet or another type of information block (e.g., a trigger frame). Generation of a data packet or an information block may include, for example, generation of control information (e.g., checksum data, communication address(es)), traffic information (e.g., payload data), scheduling information (e.g., station information, allocation information, and/or the like), or an indication, and/or formatting of such information into a specific packet header and/or preamble.

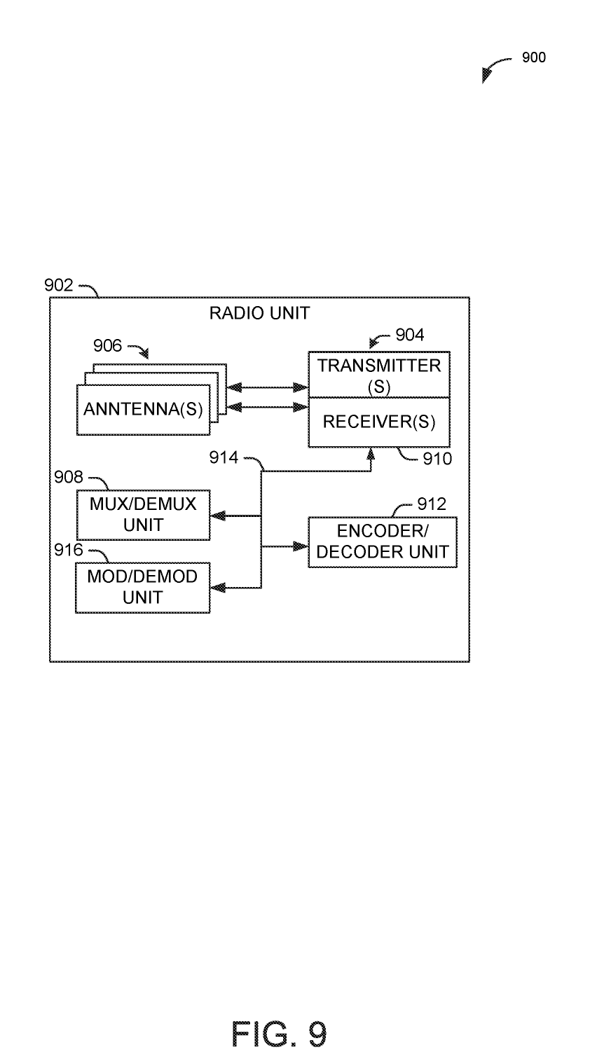

As illustrated, the radio unit 814 may include one or more antennas 816 and a multi-mode communication processing unit 818. In certain embodiments, the antenna(s) 816 may be embodied in or may include directional or omnidirectional antennas, including, for example, dipole antennas, monopole antennas, patch antennas, loop antennas, microstrip antennas, or other types of antennas suitable for the transmission of RF signals. In addition, or in other embodiments, at least some of the antenna(s) 816 may be physically separated to leverage spatial diversity and related different channel characteristics associated with such diversity. In addition or in other embodiments, the multi-mode communication processing unit 818 may process at least wireless signals in accordance with one or more radio technology protocols and/or modes (such as MIMO, MU-MIMO (e.g., multiple user-MIMO), single input multiple output (SIMO), multiple input single output (MISO), and the like. Each of such protocol(s) may be configured to communicate (e.g., transmit, receive, or exchange) data, metadata, and/or signaling over a specific air interface. The one or more radio technology protocols may include 3GPP UMTS; LTE; LTE-A; Wi-Fi protocols, such as those of the Institute of Electrical and Electronics Engineers (IEEE) 802.11 family of standards; worldwide interoperability for microwave access (WiMAX); radio technologies and related protocols for ad hoc networks, such as Bluetooth or ZigBee; other protocols for packetized wireless communication; or the like). The multi-mode communication processing unit 818 also may process non-wireless signals (analogic, digital, a combination thereof, or the like). In one embodiment (e.g., radio unit 902 shown in FIG. 9), the multi-mode communication processing unit 818 may comprise a set of one or more transmitters 904/receivers 910, and components therein (amplifiers, filters, analog-to-digital (A/D) converters, etc.), functionally coupled to a multiplexer/demultiplexer (mux/demux) unit 908, a modulator/demodulator (mod/demod) unit 916 (also referred to as modem 916), and an encoder/decoder unit 912 (also referred to as codec 912). Each of the transmitter(s)/receiver(s) may form respective transceiver(s) that may transmit and receive wireless signals (e.g., streams, electromagnetic radiation) via the one or more antennas 906. It should be appreciated that in other embodiments, the multi-mode communication processing unit 818 may include other functional elements, such as one or more sensors, a sensor hub, an offload engine or unit, a combination thereof, or the like.

Electronic components and associated circuitry, such as the mux/demux unit 908, the codec 912, and the modem 916 may permit or facilitate processing and manipulation, e.g., coding/decoding, deciphering, and/or modulation/demodulation of signal(s) received by the computing device 800 and the signal(s) to be transmitted by the computing device 800. In one aspect, as described herein, received and transmitted wireless signals may be modulated and/or coded, or otherwise processed, in accordance with one or more radio technology protocols. Such radio technology protocol(s) may include 3GPP UMTS; 3GPP LTE; LTE-A; Wi-Fi protocols, such as IEEE 802.11 family of standards (IEEE 802.ac, IEEE 802.ax, and the like); WiMAX; radio technologies and related protocols for ad hoc networks, such as Bluetooth or ZigBee; other protocols for packetized wireless communication; or the like.

The electronic components in the described communication unit, including the one or more transmitters 904/receivers 910, may exchange information (e.g., data packets, allocation information, data, metadata, code instructions, signaling and related payload data, multicast frames, combinations thereof, or the like) through a bus 914, which may embody or may comprise at least one of a system bus, an address bus, a data bus, a message bus, a reference link or interface, a combination thereof, or the like. Each of the one or more transmitters 904/receivers 910 may convert signals from analog to digital and vice versa. In addition or in the alternative, the transmitter(s) 904/receiver(s) 910 may divide a single data stream into multiple parallel data streams, or perform the reciprocal operation. Such operations may be conducted as part of various multiplexing schemes. As illustrated, the mux/demux unit 908 is functionally coupled to the one or more transmitters 904/receivers 910 and may permit processing of signals in the time and frequency domain. In one aspect, the mux/demux unit 908 may multiplex and demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), or space division multiplexing (SDM). In addition or in the alternative, in another aspect, the mux/demux unit 908 may scramble and spread information (e.g., codes) according to most any code, such as Hadamard-Walsh codes, Baker codes, Kasami codes, polyphase codes, and the like. The modem 916 may modulate and demodulate information (e.g., data, metadata, signaling, or a combination thereof) according to various modulation techniques, such as OFDMA, OCDA, ECDA, frequency modulation (e.g., frequency-shift keying), amplitude modulation (e.g., M-ary quadrature amplitude modulation (QAM), with M a positive integer; amplitude-shift keying (ASK), phase-shift keying (PSK), and the like). In addition, the processor(s) that may be included in the computing device 800 (e.g., processor(s) included in the radio unit 814 or other functional element(s) of the computing device 800) may permit processing data (e.g., symbols, bits, or chips) for multiplexing/demultiplexing, modulation/demodulation (such as implementing direct and inverse fast Fourier transforms), selection of modulation rates, and selection of data packet formats, inter-packet times, and the like.

The codec 912 may operate on information (e.g., data, metadata, signaling, or a combination thereof) in accordance with one or more coding/decoding schemes suitable for communication, at least in part, through the one or more transceivers formed from the respective transmitter(s) 904/receiver(s) 910. In one aspect, such coding/decoding schemes, or related procedure(s), may be retained as a group of one or more computer-accessible instructions (computer-readable instructions, computer-executable instructions, or a combination thereof) in one or more memory devices 834 (referred to as memory 834). In a scenario in which wireless communication among the computing device 800 and another computing device (e.g., the AP 102, the user device(s) 120, and/or other types of user equipment) utilizes MU-MIMI, MIMO, MISO, SIMO, or SISO operation, the codec 912 may implement at least one of space-time block coding (STBC) and associated decoding, or space-frequency block coding (SFBC) and associated decoding. In addition or in the alternative, the codec 912 may extract information from data streams coded in accordance with a spatial multiplexing scheme. In one aspect, to decode received information (e.g., data, metadata, signaling, or a combination thereof), the codec 912 may implement at least one of computation of log-likelihood ratios (LLRs) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 912 may utilize, at least in part, the mux/demux unit 908 and the mod/demod unit 916 to operate in accordance with the aspects described herein.

The computing device 800 may operate in a variety of wireless environments having wireless signals conveyed in different electromagnetic radiation (EM) frequency bands and/or subbands. To at least such end, the multi-mode communication processing unit 818 in accordance with aspects of the disclosure may process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion(s) of the EM spectrum. In one aspect, the set of one or more frequency bands may include at least one of (i) all or most licensed EM frequency bands, (such as the industrial, scientific, and medical (ISM) bands, including the 2.4 GHz band or the 5 GHz band); or (ii) all or most unlicensed frequency bands (such as the 60 GHz band) currently available for telecommunication.

The computing device 800 may receive and/or transmit information encoded and/or modulated or otherwise processed in accordance with aspects of the present disclosure. To at least such an end, in certain embodiments, the computing device 800 may acquire or otherwise access information, wirelessly via the radio unit 814 (also referred to as the radio 814), where at least a portion of such information may be encoded and/or modulated in accordance with the aspects described herein. More specifically, for example, the information may include prefixes, data packets, and/or physical layer headers (e.g., preambles and included information such as allocation information), a signal, and/or the like in accordance with embodiments of the disclosure, such as those shown in FIGS. 1-7.

The memory 834 may contain one or more memory elements having information suitable for processing information received according to a predetermined communication protocol (e.g., IEEE 802.11ac or IEEE 802.11ax). While not shown, in certain embodiments, one or more memory elements of the memory 834 may include computer-accessible instructions that may be executed by one or more of the functional elements of the computing device 800 in order to implement at least some of the functionality for the power control described herein, including the processing of information communicated (e.g., encoded, modulated, and/or arranged) in accordance with aspects of the disclosure. One or more groups of such computer-accessible instructions may embody or may constitute a programming interface that may permit the communication of information (e.g., data, metadata, and/or signaling) between functional elements of the computing device 800 for implementation of such functionality.

In addition, in the illustrated computing device 800, a bus architecture 842 (also referred to as bus 842) may permit the exchange of information (e.g., data, metadata, and/or signaling) between two or more of (i) the radio unit 814 or a functional element therein, (ii) at least one of the I/O interface(s) 822, (iii) the communication unit 826, or (iv) the memory 834. In addition, one or more application programming interfaces (APIs) (not depicted in FIG. 8) or other types of programming interfaces may permit the exchange of information (e.g., trigger frames, streams, data packets, allocation information, data, and/or metadata) between two or more of the functional elements of the computing device 800. At least one of such API(s) may be retained or otherwise stored in the memory 834. In certain embodiments, it should be appreciated that at least one of the API(s) or other programming interfaces may permit the exchange of information within components of the communication unit 826. The bus 842 also may permit a similar exchange of information.

FIG. 10 illustrates an example of a computational environment 1000 for power control in accordance with one or more aspects of the disclosure. The example computational environment 1000 is only illustrative and is not intended to suggest or otherwise convey any limitation as to the scope of use or functionality of such computational environment's architecture. In addition, the computational environment 1000 should not be interpreted as having any dependency or requirement relating to any one or combination of components illustrated in this example computational environment. The illustrative computational environment 1000 may embody or can include, for example, the computing device 1010, an access point 102, user device(s) 120, and/or any other computing device that may implement or otherwise leverage the power control features described herein.

The computational environment 1000 represents an example of a software implementation of the various aspects or features of the disclosure in which the processing or execution of the operations described in connection with the power control described herein, including the processing of information communicated (e.g., encoded, modulated, and/or arranged) in accordance with this disclosure, may be performed in response to the execution of one or more software components at the computing device 1010. It should be appreciated that the one or more software components may render the computing device 1010, or any other computing device that contains such components, a particular machine for the power control described herein, including the processing of information encoded, modulated, and/or arranged in accordance with the aspects described herein, among other functional purposes. A software component may be embodied in or may comprise one or more computer-accessible instructions, e.g., computer-readable and/or computer-executable instructions. At least a portion of the computer-accessible instructions may embody one or more of the example techniques disclosed herein. For instance, to embody one such method, at least the portion of the computer-accessible instructions may be persisted (e.g., stored, made available, or stored and made available) in a computer storage non-transitory medium and executed by a processor. The one or more computer-accessible instructions that embody a software component may be assembled into one or more program modules, for example, that may be compiled, linked, and/or executed at the computing device 1010 or other computing devices. Generally, such program modules comprise computer code, routines, programs, objects, components, information structures (e.g., data structures and/or metadata structures), etc., that may perform particular tasks (e.g., one or more operations) in response to execution by one or more processors, which may be integrated into the computing device 1010 or functionally coupled thereto.

The various example embodiments of the disclosure may be operational with numerous other general purpose or special purpose computing system environments or configurations. Examples of well-known computing systems, environments, and/or configurations that may be suitable for implementation of various aspects or features of the disclosure in connection with power control, including the processing of information communicated (e.g., encoded, modulated, and/or arranged) in accordance with the features described herein, may comprise personal computers; server computers; laptop devices; handheld computing devices, such as mobile tablets; wearable computing devices; and multiprocessor systems. Additional examples may include set-top boxes, programmable consumer electronics, network PCs, minicomputers, mainframe computers, blade computers, programmable logic controllers, distributed computing environments that comprise any of the above systems or devices, and the like.

As illustrated, the computing device 1010 may comprise one or more processors 1014, one or more input/output (I/O) interfaces 1016, a memory 1030, and a bus architecture 1032 (also termed bus 1032) that functionally couples various functional elements of the computing device 1010. The bus 1032 may include at least one of a system bus, a memory bus, an address bus, or a message bus, and may permit the exchange of information (data, metadata, and/or signaling) between the processor(s) 1014, the I/O interface(s) 1016, and/or the memory 1030, or the respective functional elements therein. In certain scenarios, the bus 1032 in conjunction with one or more internal programming interfaces 1050 (also referred to as interface(s) 1050) may permit such exchange of information. In scenarios in which the processor(s) 1014 include multiple processors, the computing device 1010 may utilize parallel computing.

The I/O interface(s) 1016 may permit or otherwise facilitate the communication of information between the computing device and an external device, such as another computing device, e.g., a network element or an end-user device. Such communication may include direct communication or indirect communication, such as the exchange of information between the computing device 1010 and the external device via a network or elements thereof. As illustrated, the I/O interface(s) 1016 may comprise one or more of network adapter(s) 1018, peripheral adapter(s) 1022, and display unit(s) 1026. Such adapter(s) may permit or facilitate connectivity between the external device and one or more of the processor(s) 1014 or the memory 1030. In one aspect, at least one of the network adapter(s) 1018 may couple functionally the computing device 1010 to one or more computing devices 1070 via one or more traffic and signaling pipes 1060 that may permit or facilitate the exchange of traffic 1062 and signaling 1064 between the computing device 1010 and the one or more computing devices 1070. Such network coupling provided at least in part by the at least one of the network adapter(s) 1018 may be implemented in a wired environment, a wireless environment, or both. The information that is communicated by the at least one network adapter may result from the implementation of one or more operations in a method of the disclosure. Such output may be any form of visual representation including, but not limited to, textual, graphical, animation, audio, tactile, and the like. In certain scenarios, each AP 102, user device(s) 120, station, and/or other device may have substantially the same architecture as the computing device 1010. In addition or in the alternative, the display unit(s) 1026 may include functional elements (e.g., lights, such as light-emitting diodes; a display, such as a liquid crystal display (LCD); combinations thereof; or the like) that may permit control of the operation of the computing device 1010, or may permit conveying or revealing the operational conditions of the computing device 1010.

Radio unit 1020 may comprise one or more processors, transceivers, and antennas communicatively coupled to the one or more processors and transceivers. Radio unit 1020 may transmit and receive signals using the antenna and the transceiver.

In one aspect, the bus 1032 represents one or more of several possible types of bus structures, including a memory bus or memory controller, a peripheral bus, an accelerated graphics port, and a processor or local bus using any of a variety of bus architectures. As an illustration, such architectures may comprise an industry standard architecture (ISA) bus, a micro channel architecture (MCA) bus, an enhanced ISA (EISA) bus, a Video Electronics Standards Association (VESA) local bus, an accelerated graphics port (AGP) bus, and a peripheral component interconnect (PCI) bus, a PCI-express bus, a Personal Computer Memory Card Industry Association (PCMCIA) bus, a universal serial bus (USB), and the like. The bus 1032, and all buses described herein, may be implemented over a wired or wireless network connection, and each of the subsystems, including the processor(s) 1014, the memory 1030 and memory elements therein, and the I/O interface(s) 1016 may be contained within one or more remote computing devices 1070 at physically separate locations, connected through buses of this form, in effect implementing a fully distributed system.

The computing device 1010 may comprise a variety of computer-readable media. Computer-readable media may be any available media (and non-transitory media) that may be accessed by a computing device. In one aspect, computer-readable media may comprise computer non-transitory storage media (or computer-readable non-transitory storage media) and communications media. Example computer-readable non-transitory storage media may be any available media that may be accessed by the computing device 1010, and may comprise, for example, both volatile and non-volatile media, and removable and/or non-removable media. In one aspect, the memory 1030 may comprise computer-readable media in the form of volatile memory, such as random access memory (RAM), and/or non-volatile memory, such as read-only memory (ROM).

The memory 1030 may comprise functionality instructions storage 1034 and functionality information storage 1038. The functionality instructions storage 1034 may comprise computer-accessible instructions that, in response to execution (by at least one of the processor(s) 1014), may implement one or more of the functionalities of the disclosure. The computer-accessible instructions may embody or may comprise one or more software components illustrated as power control component(s) 1036. In one scenario, execution of at least one component of the power control component(s) 1036 may implement one or more of the techniques disclosed herein. For instance, such execution may cause a processor that executes the at least one component to carry out a disclosed example method. It should be appreciated that, in one aspect, a processor of the processor(s) 1014 that executes at least one of the power control component(s) 1036 may retrieve information from or retain information in a memory element 1040 (referred to as power control information 1040) in the functionality information storage 1038 in order to operate in accordance with the functionality programmed or otherwise configured by the power control component(s) 1036. Such information may include at least one of code instructions, information structures, or the like. At least one of the one or more interfaces 1050 (e.g., application programming interface(s)) may permit or facilitate the communication of information between two or more components within the functionality instructions storage 1034. The information that is communicated by the at least one interface may result from implementation of one or more operations in a method of the disclosure. In certain embodiments, one or more of the functionality instructions storage 1034 and the functionality information storage 1038 may be embodied in or may comprise removable/non-removable, and/or volatile/non-volatile computer storage media.

At least a portion of at least one of the power control component(s) 1036 or the power control information 1040 may program or otherwise configure one or more of the processors 1014 to operate at least in accordance with the functionality described herein. One or more of the processor(s) 1014 may execute at least one of such components and leverage at least a portion of the information in the functionality information storage 1038 in order to provide power control in accordance with one or more aspects described herein. More specifically, yet not exclusively, execution of the one or more of the power control component(s) 1036 may permit transmitting and/or receiving information at the computing device 1010, as described in connection with FIGS. 1-7, for example.

It should be appreciated that, in certain scenarios, the functionality instruction(s) storage 1034 may embody or may comprise a computer-readable non-transitory storage medium having computer-accessible instructions that, in response to execution, cause at least one processor (e.g., one or more of the processor(s) 1014) to perform a group of operations comprising the operations or blocks described in connection with the disclosed methods.

In addition, the memory 1030 may comprise computer-accessible instructions and information (e.g., data and/or metadata) that permit or facilitate the operation and/or administration (e.g., upgrades, software installation, any other configuration, or the like) of the computing device 1010. Accordingly, as illustrated, the memory 1030 may comprise a memory element 1042 (labeled OS instruction(s) 1042) that contains one or more program modules that embody or include one or more operating systems, such as Windows operating system, Unix, Linux, Symbian, Android, Chromium, and substantially any operating system suitable for mobile computing devices or tethered computing devices. In one aspect, the operational and/or architectural complexity of the computing device 1010 may dictate a suitable operating system. The memory 1030 also comprises a system information storage 1046 having data and/or metadata that permits or facilitates the operation and/or administration of the computing device 1010. Elements of the OS instruction(s) 1042 and the system information storage 1046 may be accessible or may be operated on by at least one of the processor(s) 1014.

It should be recognized that while the functionality instructions storage 1034 and other executable program components, such as the OS instruction(s) 1042, are illustrated herein as discrete blocks, such software components may reside at various times in different memory components of the computing device 1010, and may be executed by at least one of the processor(s) 1014. In certain scenarios, an implementation of the power control component(s) 1036 may be retained on or transmitted across some form of computer-readable media.

The computing device 1010 and/or one of the computing device(s) 1070 may include a power supply (not shown), which may power up components or functional elements within such devices. The power supply may be a rechargeable power supply, e.g., a rechargeable battery, and it may include one or more transformers to achieve a power level suitable for operation of the computing device 1010 and/or one of the computing device(s) 1070, and components, functional elements, and related circuitry therein. In certain scenarios, the power supply may be attached to a conventional power grid to recharge and ensure that such devices may be operational. In one aspect, the power supply may include an I/O interface (e.g., one of the network adapter(s) 1018) to connect operationally to the conventional power grid. In another aspect, the power supply may include an energy conversion component, such as a solar panel, to provide additional or alternative power resources or autonomy for the computing device 1010 and/or one of the computing device(s) 1070.

The computing device 1010 may operate in a networked environment by utilizing connections to one or more remote computing devices 1070. As an illustration, a remote computing device may be a personal computer, a portable computer, a server, a router, a network computer, a peer device or other common network node, and so on. As described herein, connections (physical and/or logical) between the computing device 1010 and a computing device of the one or more remote computing devices 1070 may be made via one or more traffic and signaling pipes 1060, which may comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

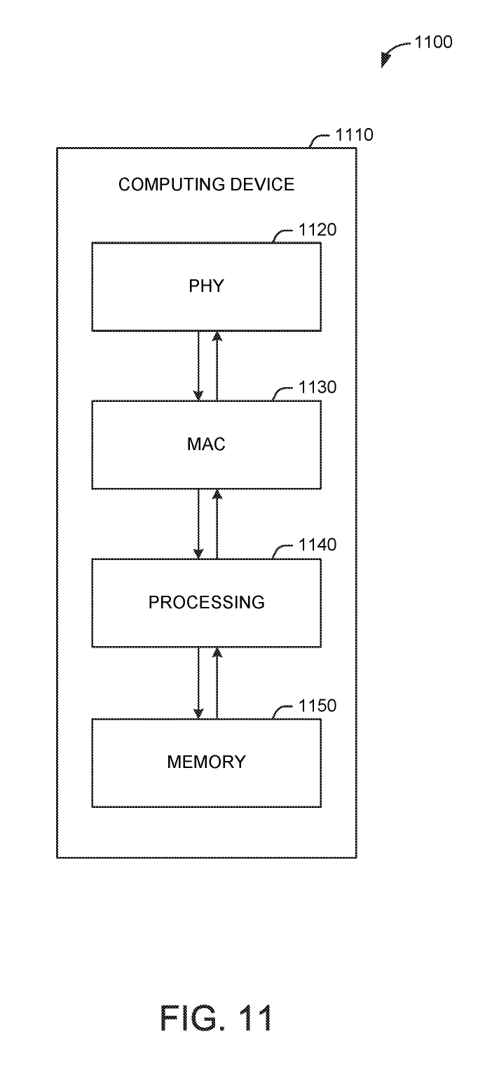

FIG. 11 presents another example embodiment 1100 of a computing device 1110 in accordance with one or more embodiments of the disclosure. In certain implementations, the computing device 1110 may be a VHT-compliant device that may be configured to communicate with one or more other VHT devices and/or other types of communication devices, such as legacy communication devices. VHT devices and legacy devices also may be referred to as VHT stations (STAs) and legacy STAs, respectively. In one implementation, the computing device 1110 may operate as an AP 102, user device(s) 120, and/or another device. As illustrated, the computing device 1110 may include, among other things, physical layer (PHY) circuitry 1120 and medium-access-control layer (MAC) circuitry 1130. In one aspect, the PHY circuitry 1120 and the MAC circuitry 1130 may be VHT compliant layers and also may be compliant with one or more legacy IEEE 802.11 standards. In one aspect, the MAC circuitry 1130 may be arranged to configure physical layer converge protocol (PLCP) protocol data units (PPDUs) and arranged to transmit and receive PPDUs, among other things. In addition or in other embodiments, the computing device 1110 also may include other hardware processing circuitry 1140 (e.g., one or more processors) and one or more memory devices 1150 configured to perform the various operations described herein.

In certain embodiments, the MAC circuitry 1130 may be arranged to contend for a wireless medium during a contention period to receive control of the medium for the VHT control period and configure a VHT PPDU. In addition or in other embodiments, the PHY circuitry 1120 may be arranged to transmit the VHT PPDU. The PHY circuitry 1120 may include circuitry for modulation/demodulation, upconversion/downconversion, filtering, amplification, etc. As such, the computing device 1110 may include a transceiver to transmit and receive data such as the VHT PPDU. In certain embodiments, the hardware processing circuitry 1140 may include one or more processors. The hardware processing circuitry 1140 may be configured to perform functions based on instructions being stored in a memory device (e.g., RAM or ROM) or based on special purpose circuitry. In certain embodiments, the hardware processing circuitry 1140 may be configured to perform one or more of the functions described herein, such as activating and/or deactivating different back-off count procedures, allocating bandwidth, and/or the like.

In certain embodiments, one or more antennas may be coupled to or included in the PHY circuitry 1120. The antenna(s) may transmit and receive wireless signals, including transmission of VHT packets. As described herein, the one or more antennas may include one or more directional or omnidirectional antennas, including dipole antennas, monopole antennas, patch antennas, loop antennas, microstrip antennas, or other types of antennas suitable for the transmission of RF signals. In scenarios in which MIMO communication is utilized, the antennas may be physically separated to leverage spatial diversity and the different channel characteristics that may result.

The memory 1150 may retain or otherwise store information for configuring the other circuitry to perform operations for configuring and transmitting VHT packets and performing the various operations described herein including the allocation and use of bandwidth (AP) and using the allocation of the bandwidth (STA).

The computing device 1110 may be configured to communicate using OFDM communication signals over a multicarrier communication channel. More specifically, in certain embodiments, the computing device 1110 may be configured to communicate in accordance with one or more specific radio technology protocols, such as the IEEE family of standards including IEEE 802.11-2012, IEEE 802.11n-2009, IEEE 802.11ac-2013, IEEE 802.11ax, DensiFi, and/or proposed specifications for WLANs. In one of such embodiments, the computing device 1110 may utilize or otherwise rely on symbols having a duration that is four times the symbol duration of IEEE 802.11n and/or IEEE 802.11ac. It should be appreciated that the disclosure is not limited in this respect and, in certain embodiments, the computing device 1110 also may transmit and/or receive wireless communications in accordance with other protocols and/or standards.

The computing device 1110 may be embodied in or may constitute a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as IEEE 802.11 or IEEE 802.16, or other types of communication devices that may receive and/or transmit information wirelessly. Similar to computing device 1010, computing device 1110 may include, for example, one or more of a keyboard, a display, a non-volatile memory port, multiple antennas, a graphics processor, an application processor, speakers, and other mobile device elements. The display may be an LCD screen including a touch screen.

It should be appreciated that while the computing device 1110 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs), and combinations of various hardware and logic circuitry for performing at least the functions described herein. In certain embodiments, the functional elements may refer to one or more processes operating or otherwise executing on one or more processors.

In example embodiments of the disclosure there may be an access point, comprising: at least one memory storing computer-executable instructions; and at least one processor configured to access the at least one memory, wherein the at least one processor is configured to execute the computer-executable instructions to cause the at least one processor to: determine the number of symbols to send to a first device; determine a fine timing measurement (FTM) response frame in response to receiving at least one FTM request frame, wherein the FTM response frame comprises the determined number of symbols; determine a null data packet (NDP) comprising the number of determined symbols; and determine to transmit the symbols in the FTM response frame to the first device.

Implementations may include one or more of the following features. The access point may further comprise at least one transceiver configured to transmit and receive wireless signals. The access point may also comprise at least one antenna coupled to the at least one transceiver. The FTM request frame may comprise an indication of a first repetition factor corresponding to the number of symbols sent from the device. The NDP may comprise a very high throughput long training field (VHT-LTF) comprising at least one symbol, and wherein the determined number of symbols is based at least in part on a first repetition factor. The FTM request frame may comprise an indication of a second repetition factor. The number of symbols may be based, at least in part, on a signal-to-noise ratio (SNR) at the transceiver and/or a transceiver in or on the device.

In some embodiments, there may be a device comprising: at least one memory storing computer-executable instructions; and at least one processor configured to access the at least one memory, wherein the at least one processor is configured to execute the computer-executable instructions to cause the at least one processor to determine the number of symbols to send to an access point (AP); determine a fine timing measurement (FTM) request frame, wherein the FTM request frame comprises the determined number of symbols; determine a first NDP comprising the determined number of symbols; determine to transmit the FTM request frame to the AP; determine to send the first NDP to the AP; receive a FTM response frame from the AP; and receive a second NDP from the AP.

Implementations may include one or more of the following features. The device may further comprise at least one transceiver configured to transmit and receive wireless signals. The device also may comprise at least one antenna coupled to the at least one transceiver. The first NDP may comprise a very high throughput long training field (VHT-LTF) comprising the determined number of symbols, and wherein the determined number of symbols is based at least in part on a first repetition factor. The FTM request frame may comprise the first repetition factor. The FTM response frame may comprise a second repetition factor. The number of symbols may be based, at least in part, on a signal-to-noise ratio (SNR) at the transceiver, and/or a transceiver in or on the access point.

In some embodiments, there may be a non-transitory computer-readable medium including instructions stored thereon, which when executed by one or more processors of an access point, cause the one or more processors to perform operations of: determining the number of symbols to send to a device; determining a fine timing measurement (FTM) response frame in response to receiving at least one FTM request frame, wherein the FTM response frame comprises the determined number of symbols; determining a null data packet (NDP) comprising the number of determined symbols; and determining to transmit the FTM response frame to the wireless device.

Implementations may include one or more of the following features. The FTM request frame may comprise an indication of a first repetition factor corresponding to the number of symbols sent from the device. The NDP may comprise a very high throughput long training field (VHT-LTF) comprising at least one symbol, wherein the number of determined symbols is based at least in part on a first repetition factor. The FTM request frame may comprise a first repetition factor. The FTM response frame may comprise a second repetition factor. The number of symbols may be based, at least in part, on a signal-to-noise ratio (SNR).

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An access point, comprising:
at least one memory storing computer-executable instructions; and
at least one processor configured to access the at least one memory, wherein the at least one processor is configured to execute the computer-executable instructions to cause the at least one processor to:
determine a number of symbols to send to a first device;
determine a fine timing measurement (FTM) response frame in response to receiving at least one FTM request frame, wherein the FTM response frame comprises the determined number of symbols;
determine a null data packet (NDP) comprising the number of determined symbols; and
determine to transmit the symbols in the FTM response frame to the first device.

2. The access point of claim 1, further comprising at least one transceiver configured to transmit and receive wireless signals.

3. The access point of claim 2, further comprising at least one antenna coupled to the at least one transceiver.

4. The access point of claim 1, wherein the FTM request frame comprises an indication of a first repetition factor corresponding to the number of symbols sent from the device.

5. The access point of claim 4, wherein the NDP comprises a very high throughput long training field (VHT-LTF) comprising at least one symbol, and wherein the determined number of symbols is based at least in part on a first repetition factor.

6. The access point of claim 5, wherein the FTM request frame comprises an indication of a second repetition factor.

7. The access point of claim 3, wherein the number of symbols is based, at least in part, on a signal-to-noise ratio (SNR) at the at least one transceiver.

8. A device comprising:
at least one memory storing computer-executable instructions; and
at least one processor configured to access the at least one memory, wherein the at least one processor is configured to execute the computer-executable instructions to cause the at least one processor to:
determine a number of symbols to send to an access point (AP);
determine a fine timing measurement (FTM) request frame, wherein the FTM request frame comprises the determined number of symbols;
determine a first null data packet (NDP) comprising the determined number of symbols;
determine to transmit the FTM request frame to the AP;
determine to send the first NDP to the AP;
receive an FTM response frame from the AP; and
receive a second NDP from the AP.

9. The device of claim 8 further comprising at least one transceiver configured to transmit and receive wireless signals.

10. The device of claim 9, further comprising at least one antenna coupled to the at least one transceiver.

11. The device of claim 8, wherein the first NDP comprises a very high throughput long training field (VHT-LTF) comprising the determined number of symbols, and wherein the determined number of symbols is based at least in part on a first repetition factor.

12. The device of claim 11, wherein the FTM request frame comprises the first repetition factor.

13. The device of claim 11, wherein the FTM response frame comprises a second repetition factor.

14. The device of claim 10, wherein the number of symbols is based, at least in part, on a signal-to-noise ratio (SNR) at the transceiver, and/or a transceiver in or on the access point.

15. A non-transitory computer-readable medium including instructions stored thereon, which when executed by one or more processors of an access point, cause the one or more processors to perform operations of:
determining a number of symbols to send to a device;
determining a fine timing measurement (FTM) response frame in response to receiving at least one FTM request frame, wherein the FTM response frame comprises the determined number of symbols;
determining a null data packet (NDP) comprising the number of determined symbols; and
determining to transmit the FTM response frame to the device.

16. The non-transitory computer-readable medium of claim 15, wherein the FTM request frame comprises an indication of a first repetition factor corresponding to the number of symbols sent from the device.

17. The non-transitory computer-readable medium of claim 15, wherein the NDP comprises a very high throughput long training field (VHT-LTF) comprising at least one symbol, wherein the number of determined symbols is based at least in part on a first repetition factor.

18. The non-transitory computer-readable medium of claim 16 wherein the FTM request frame comprises a first repetition factor.

19. The non-transitory computer-readable medium of claim 16, wherein the FTM response frame comprises a second repetition factor.

20. The non-transitory computer-readable medium of claim 15, wherein the number of symbols is based, at least in part, on a signal-to-noise ratio (SNR).
